(19) United States
(12) Patent Application Publication
(10) Pub. No.: US 2017/0045390 A1
(43) Pub. Date: Feb. 16, 2017

(54) DEVICE FOR MEASURING THE LEVEL OF A LIQUID

(71) Applicant: Valeo Systemes de Controle Moteur

(72) Inventors: Xavier Michaudet, Caen (FR); Franck Menard, Saint Germain Le Vasson (FR); Dominique Le Bouquin, Herouville Saint Clair (FR); Ludovic Riviere, Douvres La Delivrande (FR); Nicolas Renard, Ifs (FR)

(73) Assignees: Valeo Systemes de Controle Moteur, Cergy Saint Christophe (FR); Valeo Systemes de Controle Moteur, Cergy Saint Christophe (FR)

(21) Appl. No.: 15/101,732

(22) PCT Filed: Dec. 2, 2014
(86) PCT No.: PCT/FR2014/053132

§ 371 Date: Oct. 31, 2016

(30) Foreign Application Priority Data
Dec. 3, 2013 (FR) 1362035
Dec. 3, 2013 (FR) 1362038

(51) Int. Cl. G01F 23/04; H01R 4/48

(52) U.S. Cl. CPC G01F 23/04; H01R 4/4863

(57) ABSTRACT

The invention relates to a device (1) for measuring a liquid level, comprising a body (2, 8), a sensitive element arranged in the body (2,) and a connector (3) connected to the sensitive element by an electrical connection, said device comprising connection means (4) arranged in the connector, cooperating with a complementary shape (5) arranged in the body of the device, and ensuring the electrical connection, and comprising guiding means (6, 7).

This invention relates to the field of devices for measuring the level of fluid, and more particularly a device for measuring the level of liquid of a vehicle, for example a motor vehicle.

Devices for measuring the level of liquid are already known, such as for example oil level measurement probes or sensors.

These devices are conventionally formed by a body, a connector and a sensitive part arranged in the sensor body, the sensitive element being for example an electrical wire or printed circuit. These devices also comprise a part called a dip tube, which is in contact with the liquid whose level is to be measured.

Currently, the necessary electrical connection between the connector and the sensitive element is achieved by tin solder.

This type of electrical connection has the drawback of requiring on the one hand, a specific soldering operation and, on the other, an alignment of the parts, which is not easy. In fact, for the electrical connection by soldering to be effective, the connector and the sensitive part must be perfectly aligned with each other.

The aim of this invention is therefore to overcome one or more of the drawbacks of the devices of the prior art by proposing a device for measuring the level of liquid whose electrical connection is more reliable and simpler.

For this, the present invention proposes a device for measuring the level of liquid comprising a body, a sensitive element arranged in the body and a connector connected to the sensitive element by an electrical connection, the device comprising connection means, cooperating with a complementary shape, arranged in the body of the device and ensuring the electrical connection.

This type of electrical connection is simple, requires no soldering and is more reliable.

According to a first variation of the invention, the connection means are formed by at least one pin.

According to a second variation of the invention, the connection means are formed by at least one spring.

According to an embodiment of the invention, the complementary shape is at least one tab inserting itself into the spring or pin in order to make the electrical connection.

According to an embodiment of the invention, the device comprises two connection means and two tabs.

According to an embodiment of the invention, the device comprises two fittings.

According to an embodiment of the invention, the device comprises guiding means.

The guiding means allow the connector to be correctly positioned on the body of the device.

According to an embodiment of the invention, the guiding means are formed by at least one opening made directly in the body of the device or the connector of the device.

According to an embodiment of the invention, the guiding means are associated with elements of elongated shape that are fixed onto the connector or body and insert themselves into the guiding means when the connector is fitted on the body.

According to an embodiment of the invention, the guiding means and the elements of elongated shape are two in number.

According to an embodiment of the invention, the connection means, arranged in the connector, also comprise a fitting serving as an end stop for the spring.

According to an embodiment of the invention, the fitting comprises one end adapted to receive one end of the spring, and at least one end stop for the spring.

The invention also relates to an electrical connection of the device according to the invention, formed by at least one spring or pin arranged in the connector cooperating with a complementary shape arranged in the body of the device.

Further aims, characteristics and advantages of the invention will be better understood and emerge more clearly from the following description, referring to the accompanying Figures given by way of example, in which:

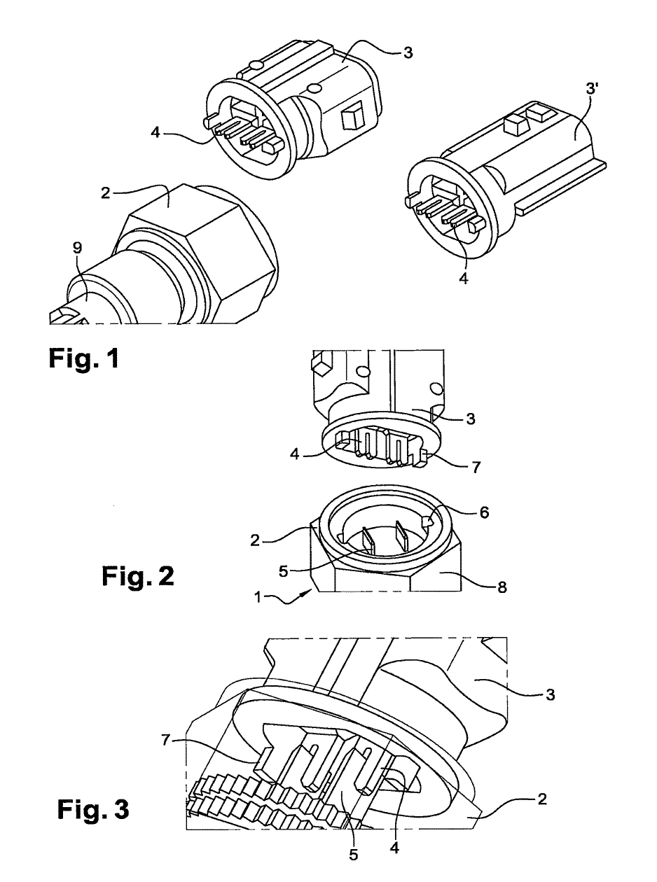

FIG. 1 is a schematic representation of a perspective view of a first variation of a device according to the invention, the connector not being electrically connected to the body,

FIG. 2 is a schematic representation of a perspective view of a first variation of a connector of the device according to the invention,

FIG. 3 is a schematic representation of a perspective view of a first variation of a body of the device according to the invention,

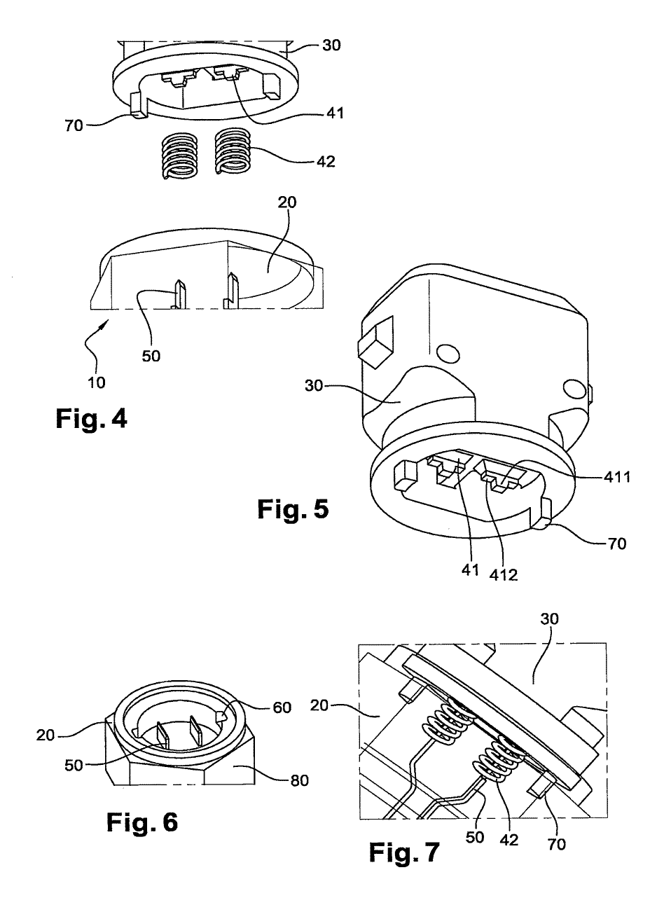

FIG. 4 is a schematic representation of a perspective view of a second variation of a device according to the invention, the connector being electrically connected to the body, the internal parts of the body being visible by transparency,

FIG. 5 is a schematic representation of a perspective view of a second variation of a device according to the invention with two connectors of different sizes,

FIG. 6 is a schematic representation of a perspective view of a second variation of a device according to the invention, the connector not being electrically connected to the body,

FIG. 7 is a schematic representation of a perspective view of a second variation of a device according to the invention, the connector being electrically connected to the body, the internal parts of the body being visible by transparency.

This invention relates to a device 1, 10 for measuring the level of a liquid.

According to an embodiment of the invention, the liquid is oil.

According to an embodiment of the invention, the device 1, 10 for measuring the level is an oil level probe for a motor vehicle.

As shown in FIGS. 1 to 7, the device 1, 10 for measuring the level of a liquid according to the invention is formed by two bodies 2, 20 forming a socket for the connector 3, 3′, 30, and a connector 3, 3′, 30.

Inside the body 2, 20 of the measuring device 1, 10 according to the invention is arranged a sensitive element, not shown.

According to an embodiment of the invention, the sensitive element is an electrical wire.

According to another embodiment of the invention, the sensitive element is a printed circuit.

The electrical connection between the connector and the sensitive element is achieved by connection means 4, 41, 42. These connection means 4, 41, 42 are arranged at one end of the connector 3, 3′. 30. These metal connection means 4, 41, 42 cooperate with a metal complementary shape 5, 50 arranged in the body 2, 20 of the measuring device.

According to a first variation of the invention, the connection means are formed by at least one pin 4.

According to a second variation of the invention, the connection means are formed by at least one spring 42.

FIGS. 1 to 3 show the first variation of the invention when the connection means are at least one pin 4.

According to an embodiment of the invention, the connector comprises two pins 4.

The complementary shape 5 arranged in the body of the device is formed by at least one tab 5.

When the connector comprises two pins 4, the body comprises two tabs 5.

The electrical connection is achieved by a forced contact between at least one pin 4 and at least one tab 5. This means that a certain force must be exerted on the pin 4 for the tab 5 to insert itself in the pin 4.

In order to facilitate the positioning of the pin 4 and the tab 5 in relation to each other, the body of the device comprises guiding means 6.

FIGS. 4 to 7 show the second variation of the invention when the connection means are at least one spring 42.

According to an embodiment of the invention, the connection means also comprise a fitting 41. The fitting 41 serves as an end stop for the spring 42. As shown in FIG. 5, the fitting 41 comprises an end 411 adapted to receive an end of the spring 42, and at least one end stop 412 for the spring 42. More precisely, the fitting 41 comprises an end 411 comprising two shoulders 412 serving as end stops for the spring. The end 411 of the fitting 41 is inserted in the spring 42, which thus comes to rest on the two shoulders 412. The fitting 41 is arranged on one end of the connector 3. The second end of the spring 42 cooperates with a metal complementary shape 50 arranged in the body 20 of the measuring device.

The complementary shape 50 arranged in the body of the device is formed by at least one tab 50. The tab is configured so as to be able to insert itself in the second end of the spring 42, and so as to be in contact with the spring 42 to enable an electrical connection. The tab 50 is electrically connected to the sensitive element in a conventional manner.

According to an embodiment of the invention, the connector 30 comprises two fittings 41.

When the connector 30 comprises two fittings 41, the device comprises two springs 42 and the body 20 comprises two tabs 50.

The electrical connection is achieved by a contact between the spring 42 and the fitting 41 on the one hand, and the spring 42 and the tab 50 on the other. The assembly thus enables the electrical connection between the connector 20 and the sensitive element.

In order to facilitate positioning of the fitting 41 on the spring 42 and the tab 50 in relation to each other, the body 20 of the device comprises guiding means 6.

According to an embodiment of the two variations of the invention, the guiding means 6, 60 are formed by at least one opening 6, 60 made directly in the body 2, 20. This opening 6, 60 can be in the form of a hole or slot. These guiding means 6, 60 are associated with elements 7, 70 of elongated form fixed onto the connector 3, 30 and that insert themselves into the opening 6, 60 when the connector 3, 30 is fitted onto the body 2, 20. The guiding means 6, 60 and the elements 7, 70 of elongated form are therefore arranged, in relation to each other, and on the body 2, 20 and the connector 3, 3′, 30, to enable the connection means to be guided so that the tab 5, 50 inserts itself into the spring 42 or pin 4.

According to another embodiment of the invention, not shown, the guiding means are formed by at least one opening made directly in the connector. This opening can be in the form of a hole or slot. These guiding means are associated with elements with an elongated form fixed to the body and which insert themselves in the opening when the connector is fitted onto the body. The guiding means and the elements of elongated form are therefore arranged, in relation to each other, and on the body and the connector, so as to enable the connection means to be guided.

This type of connection thus enables the cost of assembly between the connector and the body to be reduced and avoids existing soldering wastage.

The device according to the invention enables the connection of different types of connector. In fact, any type of connector can be equipped with connection means such as those of the present invention.

According to an embodiment of the invention, the device comprises a dip tube 9.

A dip tube means the part that must be immersed in the liquid whose level is to be measured.

According to an embodiment of the invention, the connector 3, 30 comprises a threaded part, not shown.

The threaded part enables the device 1, 10 to be fitted onto a support, not shown. This support is for example a wall of an engine sump.

The body 2, 20 of the device 1, 10 comprises plastic or metal gripping means 8, 80. These gripping means 8, 80 serve as holding means when screwing the device onto a support. These gripping means 8, 80 serve for example as an interface with a screwdriver.

According to an embodiment of the invention, the gripping means 8, 80 have the shape of a nut and comprise at least three facets.

According to an embodiment of the invention, the device 1, 10 also comprises an elongated smooth part, not shown, arranged between the threaded part and the gripping element. This part serves to prevent direct contact of the gripping element with the support onto which the device is screwed.

The scope of the present invention is not limited to the above details and allows embodiments under numerous other specific forms without departing from the field of application of the invention. Consequently, the present embodiments must be deemed to be for illustrative purposes and can be modified without, however, departing from the scope defined by the claims.

1. A device for measuring the level of a fluid comprising:
a body;
a sensitive element arranged in the body;
a connector connected to the sensitive element by an electrical connection; and
connection means, formed by at least one spring or one pin, cooperating with a complementary shape, arranged in the body of the device, and ensuring the electrical connection.

2. The device according to claim 1, wherein the complementary shape is at least one tab inserting itself into the spring or pin in order to make the electrical connection.

3. The device according to claim 2, comprising two connection means and two tabs.

4. The device according to claim 1, comprising guiding means.

5. The device according to claim 3, wherein the guiding means are formed by at least one opening made directly in the body of the device or in the connector of the device.

6. The device according to claim 6, wherein the guiding means are associated with elements of elongated shape that are fixed onto the connector and insert themselves into the guiding means when the connector is fitted on the body.

7. The device according to claim 7, wherein the guiding means and the elements of elongated shape are two in number.

8. The device according to claim 1, wherein the connection means arranged in the connector also comprise a fitting serving as an end stop for the spring.

9. The device according to claim 8, wherein the fitting comprises one end adapted to receive one end of the spring, and at least one end stop for the spring.

10. An electrical connection of the device according to claim 1, formed by at least one spring or pin, arranged between a connector and a body, cooperating with a complementary shape arranged in the body of the device.
